(19) United States
(12) Patent Application Publication
(10) Pub. No.: US 2025/0232500 A1
(43) Pub. Date: Jul. 17, 2025

(54) SYSTEMS AND METHODS FOR GENERATING AN AI-ASSISTED USER INTERFACE AND PROCESSING A USER REQUEST TO SAID INTERFACE

(71) Applicant: Klick Inc., Toronto (CA)

(72) Inventor: Curt Basher, Toronto (CA)

(21) Appl. No.: 19/012,143

(22) Filed: Jan. 7, 2025

Related U.S. Application Data
(60) Provisional application No. 63/619,768, filed on Jan. 11, 2024.

(51) Int. Cl. G06T 11/60; G06F 40/18; G06F 40/40

(52) U.S. Cl. CPC G06T 11/60; G06F 40/18; G06F 40/40; G06T 2200/24

(57) ABSTRACT

Described are systems and methods for providing AI and ML-assisted workflows, and more specifically, to improved systems and methods for creating user interfaces for software applications that interact with AI models. A computer-implemented system and method for generating an AI-assisted user interface comprises providing, at a memory, a page element database comprising a plurality of page element configurations; receiving, at a network device, a page generation request from a user at a user device; generating, at a processor in communication with the memory and the network device, an AI-assisted user interface comprising a plurality of page elements, each of the plurality of page elements generated based on a corresponding page element configuration in the plurality of page element configurations; outputting, at a display device in communication with the processor, the AI-assisted user interface; and wherein the plurality of page element configurations comprises at least one AI-based page element configuration.

### CROSS-REFERENCE TO RELATED APPLICATION

This application claims the benefit of U.S. Provisional Application No. 63/619,768 filed on Jan. 11, 2024, which is incorporated by reference herein in its entirety.

### FIELD

The present disclosure is directed to systems and methods for providing AI and ML-assisted workflows, and more specifically, to improved systems and methods for creating user interfaces for software applications that interact with generative AI systems.

### BACKGROUND

The following is not an admission that anything discussed below is part of the prior art or part of the common general knowledge of a skilled in the art.

The explosion of available generative AI models has led to an associated explosion of user interfaces and software applications that attempt to leverage these generative AI models. However, software applications cannot usually be easily tailored to an organization or a team's specific needs. Existing tools tend to only support interfacing with one or very few available AI models out of all of the available solutions.

Organizations aiming to adapt AI solutions for various needs face several technological and economic barriers. Technical know-how is required, and a significant time investment is usually necessary to successfully perform these adaptations. Existing tools that for creating web-based user interfaces and software applications for different applications generally lack features that provide robust integration with AI systems.

There remains a need for improved systems and methods directed to creating user interfaces and software applications that can interact with generative AI systems.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

The present disclosure is directed to systems and methods for generating an AI-assisted user interface and processing a user request to said interface.

In an aspect of this disclosure, there is provided a computer-implemented method for generating an AI-assisted user interface may comprise providing, at a memory, a page element database comprising a plurality of page element configurations; receiving, at a network device, a page generation request from a user at a user device; generating, at a processor in communication with the memory and the network device, an AI-assisted user interface comprising a plurality of page elements, each of the plurality of page elements generated based on a corresponding page element configuration in the plurality of page element configurations; outputting, at a display device in communication with the processor, the AI-assisted user interface; and wherein the plurality of page element configurations may comprise at least one AI-based page element configuration.

The at least one AI-based page element configuration may include at least one selected from the group of an AI-based text generation page element configuration, an AI-based image generation page element configuration, an AI speech generation page element configuration.

The AI-based text generation page element configuration may include configuration for at least two Large Language Models (LLMs).

The AI-based image generation page element configuration may include configuration for at least two Image Generation Models (IGMs).

The AI-based speech generation page element configuration may include configuration for at least two Speech Models (SMs).

The page element database may include a spreadsheet.

The spreadsheet may comprise a remote cloud-based spreadsheet system. The remote cloud-based spreadsheet system may optionally be Google® Sheets®.

The plurality of page element configurations may include at least one selected from the group of: a static page element, an input page element, and an output page element.

The display device may be in network communication with the processor and located at the user device.

the disclosed methods may be performed by a computer-implemented system for generating an AI-assisted user interface, comprising a memory, a network device, and a processor in communication with the memory and the network device, the processor configured to perform the methods.

In an aspect of this disclosure, there is provided a computer-implemented method for processing a user request from an AI-assisted user interface, the method comprising providing, at a memory, a page element database comprising a plurality of page element configurations, the plurality of page element configurations comprising at least one AI-based page element configuration; receiving, at a network device, a user request from a user at a user device, the user request corresponding to a user submission on an AI-assisted user interface; identifying, at a processor in communication with the network device and the memory, an AI-based page element configuration corresponding to the user submission; selecting, at the processor, a model from at least two models in the AI-based page element configuration; generating, at the processor, a response to the user request by: sending, using the network device, a model request to the selected model; and receiving, using the network device, a model response; and outputting, at a display device in communication with the processor, the AI-assisted user interface comprising the model response.

The at least one AI-based page element configuration may include at least one selected from the group of an AI-based text generation page element configuration, an AI-based image generation page element configuration, an AI speech generation page element configuration.

The AI-based text generation page element configuration may include configuration for at least two Large Language Models (LLMs).

The AI-based image generation page element configuration may include configuration for at least two Image Generation Models (IGMs).

In one or more embodiments, the AI-based speech generation page element configuration may comprise configuration for at least two Speech Models (SMs).

The page element database may include a spreadsheet.

The spreadsheet may include a remote cloud-based spreadsheet system. The remote cloud-based spreadsheet system may optionally be Google® Sheets®.

The display device may be in network communication with the processor and located at the user device.

The methods described herein may be performed by a computer-implemented system for processing a user request from an AI-assisted user interface, comprising: a memory, a network device, a processor in communication with the memory and the network device, the processor configured to perform the methods.

It will be appreciated by a person skilled in the art that an apparatus, computer program product, system, or method disclosed herein may embody any one or more of the features contained herein and that the features may be used in any particular combination or sub-combination.

These and other aspects and features of various examples will be described in greater detail below.

### DRAWINGS

For a better understanding of the described examples and to show more clearly how they may be carried into effect, reference will now be made, by way of example, to the accompanying drawings in which:

FIG. 1 shows a system diagram of an example AI-assisted software generation system.

FIG. 2 shows a block diagram of an example computing device that can be used with the system of FIG. 1.

FIG. 3 shows a flowchart of an example method for rendering a user interface on a user device.

FIG. 4 shows a flowchart of an example method of processing user input received through a user interface.

FIG. 5 shows a user interface diagram of an example page element configuration interface.

FIG. 6 shows a user interface diagram of an example user interface that may be rendered on a user device.

FIG. 7 shows a flowchart of an example method for generating an AI-assisted user interface.

FIG. 8 shows another flowchart of an example method of processing user input received through a user interface.

The drawings, described below, are provided for purposes of illustration, and not of limitation, of the aspects and features of various examples described herein. For simplicity and clarity of illustration, elements shown in the drawings have not necessarily been drawn to scale. The dimensions of some of the elements may be exaggerated relative to other elements for clarity.

### DESCRIPTION OF VARIOUS EMBODIMENTS

Various apparatuses or methods will be described below to provide an example of the claimed subject matter. No example described below limits any claimed subject matter and any claimed subject matter may cover methods or apparatuses that differ from those described below. The claimed subject matter is not limited to apparatuses or methods having all of the features of any one apparatus or methods described below or to features common to multiple or all of the apparatuses or methods described below. It is possible that an apparatus or methods described below is not an example that is recited in any claimed subject matter. Any subject matter disclosed in an apparatus or methods described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It should also be noted that the terms “coupled” or “coupling” as used herein can have several different meanings depending on the context in which these terms are used. For example, the terms “coupled”, or “coupling” can have a mechanical, electrical or communicative connotation. For example, as used herein, the terms “coupled”, or “coupling” can indicate that two elements or devices can be directly connected to one another or connected to one another through one or more intermediate elements or devices via an electrical element, electrical signal or a mechanical element depending on the particular context. Furthermore, the term “communicative coupling” indicates that an element or device can electrically, optically, or wirelessly send data to another element or device as well as receive data from another element or device.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

The example systems and methods described herein may be implemented in hardware or software, or a combination of both. In some cases, the examples described herein may be implemented, at least in part, by using one or more computer programs, executing on one or more programmable devices comprising at least one processing element, a data storage element (including volatile and non-volatile memory and/or storage elements), and at least one communication interface. These devices may also have at least one input device (e.g., a keyboard, a mouse, a touchscreen, and the like), and at least one output device (e.g., a display screen, a printer, a wireless radio, and the like) depending on the nature of the device. For example, and without limitation, the programmable devices (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some examples, the communication interface may be a network communication interface. In examples in which elements are combined, the communication interface may be a software communication interface, such as those for inter-process communication (IPC). In still other examples, there may be a combination of communication interfaces implemented as hardware, software, and a combination thereof.

Program code may be applied to input data to perform the functions described herein and to generate output information. The output information is applied to one or more output devices, in known fashion.

Each program may be implemented in a high-level procedural, declarative, functional or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Examples of the system may also be considered to be implemented as a non-transitory computer-readable storage medium, configured with a computer program, where the storage medium so configured causes a computer to operate in a specific and predefined manner to perform the functions described herein.

Furthermore, the example system, processes and methods are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Various examples of systems, methods and computer programs products are described herein. Modifications and variations may be made to these examples without departing from the scope of the invention, which is limited only by the appended claims. Also, in the various user interfaces illustrated in the figures, it will be understood that the illustrated user interface text and controls are provided as examples only and are not meant to be limiting. Other suitable user interface elements may be used with alternative implementations of the systems and methods described herein.

With the explosion of generative AI, there are many needs that are not being met by conventional solutions. This includes a lack of efficient tools that allow for the intelligent selection of generative AI engines and tools. As well, individuals are restricted in their use of tools from outside their organization due to data concerns (e.g. using client data to train models or fine-tune models). As well, tools that leverage the existing wealth of data & information at an organization (i.e. integrated with unique systems and data sources), are lacking.

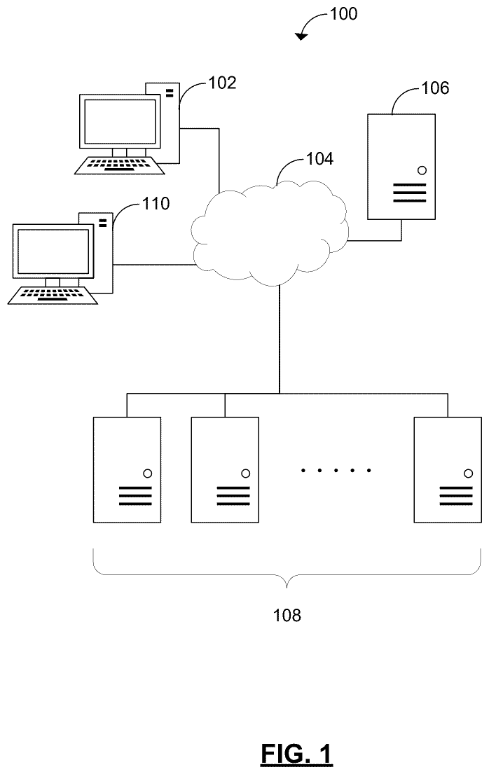

Referring first to FIG. 1, there is shown a system diagram 100 of an example system for generating software applications that interface with a plurality of generative AI (artificial intelligence) models. The example system 100 allows for the generation of applications that incorporate configurable, multi-staged, chained AI actions. The example system 100 also allows functionality and user interfaces to be easily customized and configured for software applications without the use of coding or scripting.

Pre-trained AI models often benefit from fine-tuning via carefully crafted prompts as well as further prompting based on outputs of previous prompts. Such processes often elicit more detailed and precise outputs than otherwise would be obtained. The systems and methods described herein enable users to create and configure tools incorporating these concepts into one customizable interface, thus producing better overall results for creative workflows using generative AI. The systems and methods described herein can enable users to leverage a carefully designed, multi-staged, and flexible generative AI workflow within a customizable user interface without requiring any knowledge of coding.

As shown in FIG. 1, the example user interface generation system 100 includes one or more user devices 102, a network 104, one or more servers 106, one or more generative AI systems 108, and one or more developer devices 110.

Each user device 102 may be used by a user such as a consultant, a marketing professional, a medical professional, a creative professional, or any other user of a custom software application that leverages a plurality of AI actions from one or more LLMs. For example, a user device 102 may be used to access an end-user software application, for instance an application generated in response to interactions between a developer device 110 and server 106.

Each user device 102 may be any two-way communication device with capabilities to communicate with other devices. The user device 102 can generally be in communication with (or able to establish communication with) server 106. As will be understood, a user device 102 may be any suitable computing device capable of executing an application. User device 102 generally refers to a computing device such as desktop or laptop computers, smartphones, tablet computers, as well as a wide variety of “smart” devices capable of data communication. Each user devices 102 includes a processor, a volatile and non-volatile memory, at least one network interface, and input/output devices. User devices 102 may be portable, and may at times be connected to network 104 or a portion thereof. A user device 102 may be, for example, a mobile device such as mobile devices running the Google® Android® operating system or Apple® iOS® operating system. A user device 102 may also be, for example, a personal computer operating the Windows® or MacOS® operating system.

Each of the user devices 102 can have a plurality of software applications operating thereon. The plurality of software applications can include an end-user application that can be used by the user of user device 102 in order to perform actions using one or more generative AI systems 108. The user device 102 may communicate with server 106 using an Application Programming Interface (API) endpoint, and may send various inputs and other requests for processing at the one or more generative AI systems 108.

The user device 102 may be operated by a user to access a web-based end-user application (not shown) running on server 106 over network 104. Optionally, a user device 102 may access a web application hosted at server 106 using a browser application operating on the user device 102. Alternatively or in addition, the end-user application may be a standalone program (or software application) that is downloaded and installed on the user device 102. A user device 102 may download the end-user application (including downloading from an App Store such as the Apple® App Store or the Google® Play Store).

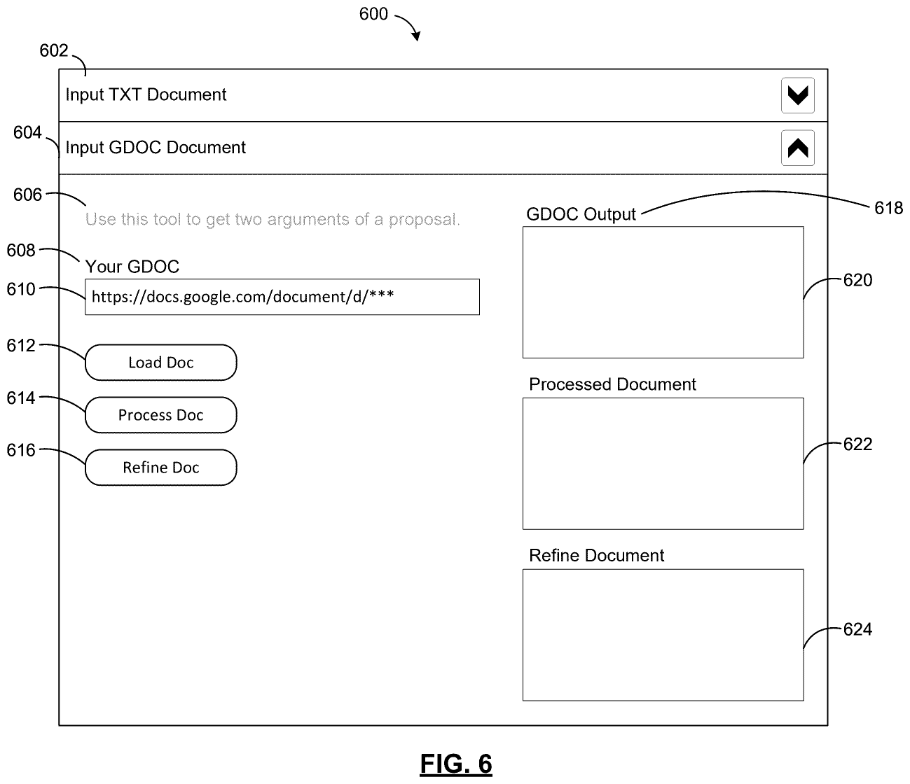

The end-user application can include a user interface that accepts inputs in various forms, such as text or image. For example, the end-user software application may display one or more user interfaces on a display device of the user device, including, but not limited to, the user interface shown in FIG. 6.

A developer device 110 may be used to create or configure a standardized generative AI-based workflow that utilizes chained actions of one or more generative AI, for instance using a development software application. The developer device 110 may be used by a developer user such as a consultant, a marketing professional, a medical professional, a creative professional, or any other individual that desires to create or configure a standardized generative AI-based workflow without requiring the use of coding.

Each developer device 110 may be any two-way communication device with capabilities to communicate with other devices. The developer device 110 can generally be in communication with (or able to establish communication with) server 106. As will be understood, a developer device 110 may be any suitable computing device capable of executing an application. developer device 110 generally refers to a computing device such as desktop or laptop computers, smartphones, tablet computers, as well as a wide variety of “smart” devices capable of data communication. Each developer device 110 includes a processor, a volatile and non-volatile memory, at least one network interface, and input/output devices. Developer device 110 may be portable, and may at times be connected to network 104 or a portion thereof.

A developer device 110 may be, for example, a mobile device such as mobile devices running the Google® Android® operating system or Apple® iOS® operating system. A developer device 110 may also be, for example, a personal computer operating the Windows® or MacOS® operating system.

A developer device 110 may be the personal device of a user or may be a device provided by an employer. The one or more developer devices 110 may be used by a developer to access the developer software application (not shown) running on server 106 over network 104. The developer device 110 can communicate with server 106 to enable a process of creating or configuring an end-user software application to perform actions using one or more generative AI systems 108.

The developer device 110 may be operated by a user to access a web-based developer software application (not shown) running on server 106 over network 104. Optionally, a developer device 110 may access a web application hosted at server 106 using a browser application operating on the user device 102.

Alternatively or in addition, the developer software application may be a standalone program (or software application) that is downloaded and installed on the developer device 110. A developer device 110 may download the developer software application (including downloading from an App Store such as the Apple® App Store or the Google® Play Store).

Optionally, the developer software application may provide a spreadsheet-based interface that enables a user to input user interface elements for an end-user software application.

The developer software application running on the one or more developer devices 110 may communicate with server 106 using an Application Programming Interface (API) endpoint, and may create, update, read and delete page element configurations for an end-user software application.

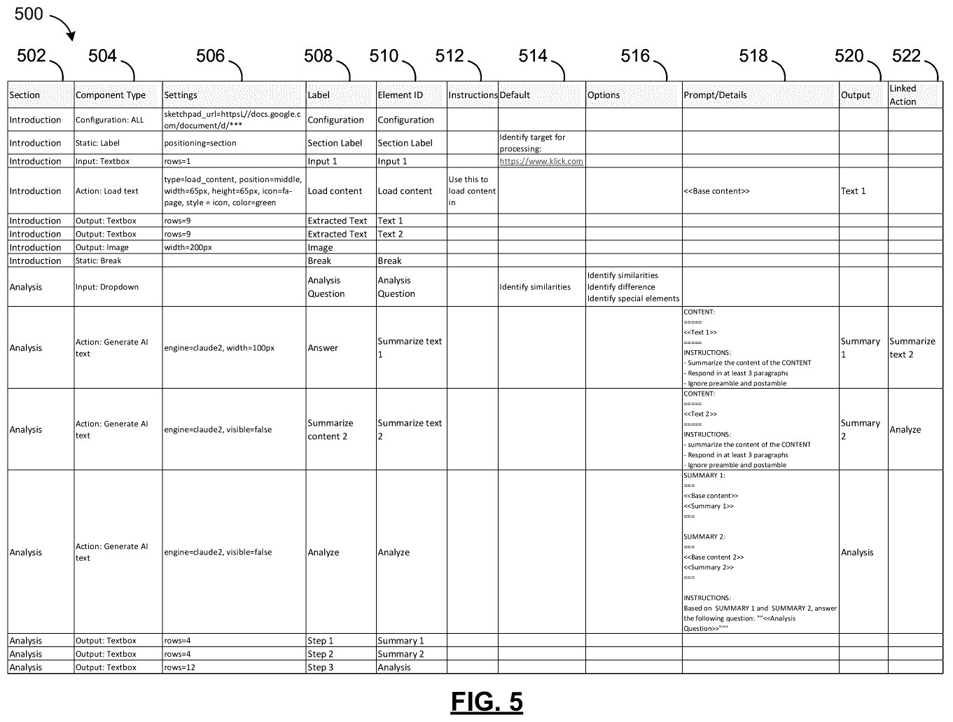

The developer software application can configure the developer device 110 to display one or more user interfaces on a display device of the developer device 100, including, but not limited to, the example user interfaces shown in FIG. 5.

It should be noted that, for the purposes of describing the functionality of the system, any action performed by user device 102 as described herein can also be performed by developer device 110 in the context of regular usage or in the context of development and debugging, even if not explicitly stated. It should also be understood that the same computing device may operate as both a user device 102 (e.g. when accessing and interacting with an end-user application) and a developer device 110 (e.g. when accessing and interacting with a developer software application).

Network 104 may be any network or network components capable of carrying data including the Internet, Ethernet, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

Server 106 is a computer server that is connected to network 104. Server 106 has a processor, volatile and non-volatile memory, at least one network interface, and may have various other input/output devices. As with all devices shown in the system 100, there may be multiple servers 106, although not all are shown.

It will be understood that the server 106 need not be a dedicated physical computer. The various logical components that are shown as being provided on or by server 106 may be hosted by a third party “cloud” hosting service such as Amazon™ Web Services™ for example.

The server 106 is in network communication with the one or more user devices 102 and the one or more developer devices 110. The server 106 may host a web application or an Application Programming Interface (API) endpoint that the one or more user devices 102 and the one or more developer devices 110 may interact with via network 104. The requests made to the API endpoint of server 106 may be made in a variety of different formats, such as JavaScript Object Notation (JSON) or extensible Markup Language (XML).

One or more generative AI systems 108 are in network communication with the server 106. The generative AI systems may be accessed by the server 106 using an API of the generative AI systems 108. The generative AI system 108 may use a pre-trained AI model (e.g. GPT-4 or similar) to process inputs from the user device 102 via the server 106 and produce outputs for display on the user device 102. Detailed prompts and predefined crafted prompts provided by the server 106 may enable the generative AI 108 to adapt to the volume and type of input data without making any modifications to its base model. The one or more generative AI systems 108 may include one or more Large Language Models (LLMs), one or more Image Generation Models (IGMs), and one or more Speech Models (SMs).

The one or more generative AI systems 108 may include various types, models and versions of generative AI systems, including but not limited to one or more of the following example systems:
GPT-2 made by OpenAI®
GPT-3 made by OpenAI®
GPT-3.5 Turbo made by OpenAI®
Claude 1 made by Anthropic®
Claude 2 made by Anthropic®
BLIP made by Salesforce®
LaMDA (Language Models for Dialog Applications) made by Google®
LLaMA (Large Language Model Meta AI) made by Meta®
GPT-4 made by OpenAI®
GPT-4 Turbo made by OpenAI®
PaLM 2 (Pathways Language Model 2) Google®
Llama 2 made by Meta®
SDXL made by Stability AI®
Dall-E made by OpenAI®
Google Cloud Platform by Google®
ElevenLabs®
D-ID®

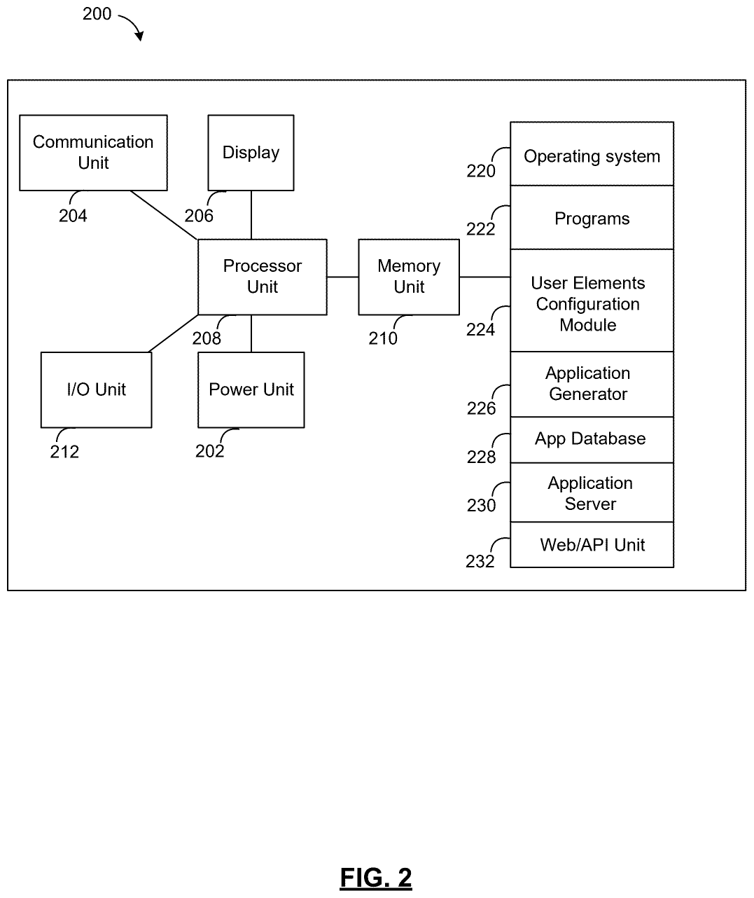

Referring next to FIG. 2, there is shown a block diagram of an example server device 200 that may be used as server 106 in the example system 100 shown in FIG. 1.

The communication unit 204 can include wired or wireless connection capabilities. The communication unit 204 can include a radio that communicates using standards such as IEEE 802.11a, 802.11b, 802.11g, or 802.11n. The communication unit 204 can be used by the server 106 to communicate with other devices or computers.

Communication unit 204 may communicate with a network, such as network 104 (see FIG. 1).

The display 206 may be an LED or LCD based display and may be a touch sensitive user input device that supports gestures. Optionally, display 206 may be omitted, for instance where the server 200 is a virtual server or is accessed through a separate device such as a user device 102 or developer device 110.

The processor unit 208 controls the operation of the server 106. The processor unit 208 can be any suitable processor(s), controller(s) or digital signal processor(s) that can provide sufficient processing power depending on the configuration, purposes and requirements of the server 106 as is known by those skilled in the art. For example, the processor unit 208 may be a high-performance general processor. Alternatively or in addition, the processor unit 208 can include more than one processor with each processor being configured to perform different dedicated tasks. Alternatively or in addition, the processor unit 208 may include a standard processor, such as an Intel® processor or an AMD® processor.

The memory unit 210 can include RAM, ROM, one or more hard drives, one or more flash drives or some other suitable data storage elements such as disk drives, etc. The memory unit 210 is used to store an operating system 220 and programs 222 as is commonly known by those skilled in the art.

The memory unit 210 stores software code for implementing an operating system 220, programs 222, User Elements Configuration Module 224, Web Application Generator 226, App Database 228, Application Server 230, and Web/API Unit 230.

The I/O unit 212 can include at least one of a mouse, a keyboard, a touch screen, a thumbwheel, a trackpad, a trackball, a card-reader, an audio source, a microphone, voice recognition software and the like again depending on the particular implementation of the server 106. Optionally, some of these components can be integrated with one another. Optionally, the I/O unit 212 may be omitted from server 106.

The power unit 216 can be any suitable power source that provides power to the server 106 such as a power adaptor or a rechargeable battery pack depending on the implementation of the server 106 as is known by those skilled in the art.

The operating system 220 may provide various basic operational processes for the server 200. For example, the operating system 220 may be a server operating system such as Ubuntu® Linux, Microsoft® Windows Server® operating system, or another operating system.

The programs 222 include various user programs. They may include several hosted applications delivering services to users over the network, for example, a marketing customer relations management (CRM) system.

The user elements configuration module 224 can be used to define the configuration of page elements of an end-user application to be provided to a user. The user elements configuration module 224 can receive inputs from a developer device 100 that is operate a developer software application to create and configure user interface elements for an end-user software application. The user elements configuration module 224 can create, modify, or delete one or more configurations of page elements of the end-user software application in response to inputs received from the developer device 110.

Server 200 may receive page element configuration inputs over the communication unit 204 from the developer device 110. The page element configuration inputs can be defined to create, delete, or update a page element configuration for a particular end-user software application. In some cases, creating or deleting a page element configuration may be considered equivalent to creating or deleting the corresponding page element, in that the existence of the configuration implies the existence of the page element, and the deletion of the configuration implies the deletion of the page element. Alternatively, the existence of a page element and the page element configuration for that page element may be defined separately.

The user elements configuration module 224 may take the form of any tool that allows for the organization and management of data. Optionally, the user elements configuration module may include a spreadsheet software or a database. The spreadsheet software may produce spreadsheets that can be stored locally in formats such as .xlsx, .xls, .csv, or any other spreadsheet format. Optionally, the spreadsheet software may use a remote cloud-based spreadsheet system such as Google® Sheets®.

Optionally, the user elements configuration module may include a flow chart. Optionally, the user elements configuration module may include a relational database. An example showing the contents of a page element database in the form of a spreadsheet can be seen in FIG. 5.

Optionally, the user elements configuration module 224 can have a set of available page elements. The user elements configuration module 224 can also have a set of available page element configurations for the page elements in the set of available page elements. Alternatively, the user elements configuration module 224 may allow a user to define new page elements and/or new configurations for page elements through the developer software application.

The set of available page elements may include static page elements. Static page elements may include such elements as labels, iFrames, and breaks.

The set of available page elements may include input page elements. Input page elements can include elements that enable users to provide input such as, for example, as textboxes, dropdowns, radio controls, and hidden fields.

The set of available page elements may include output page elements. Output page elements may include elements that can provide an output to a user following a particular action such as, for example, textboxes, images, videos, and audio.

The set of available page elements may include one or more action elements. An action elements can be defined to perform an action by executing predefined code or script based on input parameters (e.g. input parameters received from a user operating the end-user application). The action elements can include AI-based page elements. AI-based page elements can include one or more elements selected from the group of AI-based text generation page elements, AI-based image generation page elements, and AI speech generation page elements.

AI-based text generation page elements may include elements configured to process inputs and produce outputs using one or more large language model systems, for example GPT3.5 Turbo, GPT4, GPT4 Turbo, Claude1, Claude2, or Blip. Each AI-based text generation page element can have an associated predefined text generation prompt. The predefined text generation prompt can be configured to cause the corresponding LLM system to generate text in a specified manner based on inputs from the user interacting with the AI-assisted user interface.

The AI-based image generation page elements may include elements configured to process inputs and produce outputs using one or more text-to-image models, for example SDXL, Dall-E2, Dall-E3. Each AI-based image generation page element can have an associated predefined image generation prompt. The predefined image generation prompt can be configured to cause the corresponding text-to-image system to generate image data in a specified manner based on inputs from the user interacting with the AI-assisted user interface.

The AI-based speech generation page elements may include elements configured to process inputs and produce outputs using one or more text-to-speech models, for example using models such as those provided by GCP or ElevenLabs. Each AI-based speech generation page element can have an associated predefined speech generation prompt. The predefined speech generation prompt can be configured to cause the corresponding text-to-speech system to generate speech data in a specified manner based on inputs from the user interacting with the AI-assisted user interface.

The AI-based page elements may further comprise video generation page elements configured to process inputs and produce outputs using video generation models, for example using models such as D-ID. Each AI-based video generation page element can have an associated predefined video generation prompt. The predefined video generation prompt can be configured to cause the corresponding video generation system to generate video data in a specified manner based on inputs from the user interacting with the AI-assisted user interface.

The AI-based page elements may further include knowledge graph page elements configured to process inputs and knowledge graph generation produce outputs using knowledge graph generation models.

The AI-based elements can also include various additional AI-based elements that make use of AI models to perform various tasks in an automated manner. Each AI-based element can have an associated predefined prompt configured to cause the corresponding system to perform the desired type of action in a specified manner based on inputs from the user interacting with the AI-assisted user interface. For example, the AI-based page elements may include elements that use AI to perform the following tasks:
Text to text conversion (e.g., making summaries, categorization, translation, composition, etc.)
Text to image conversion (with and without words)
Text to speech conversion (e.g. producing audio narration)
Image to text conversion (e.g. producing rich description of an image, drawing/writing extraction, image comparison)
Video editing and creation (e.g. narration, stitching, interrogation)
Multimodal file conversion (e.g. Excel file+text to create text+PDF+image)
Sequenced conversion (e.g. data file to create knowledge graph)

The action elements may include text loading action elements. The text loading action elements may include actions to load text from various text sources internal or external to an organization, such as proprietary text reports, BQ, ElasticSearch, Google Docs, Google Slides web pages/sites, and sitemaps. Text loading action elements may be defined to include, for example, code configured to scrape text from the various text sources and load them into an output textbox element.

The action elements may include text saving action elements. The text saving action elements may include actions defined to save text to various output text locations such as a database or to applications such as Google Docs and Google Slides.

The action elements may further include combination of fields action elements. The combination of fields action elements may include actions defined to combine one or more different fields together into one or more output textboxes.

The action elements may include folder indexing actions.

The action elements may include sitemap generation functions.

The action elements may further comprise various miscellaneous functions such as, but not limited to, actions define to: combine text, open a browser and navigate to a specific URL, grade level, sentiment.

The set of available page elements may further include general elements such as: elements configured to save a current configuration of the plurality of page element configurations, elements configured to load a previous configuration of the plurality of page element configurations, elements configured for sketchpad support, and elements configured to provide general control over a layout of the application.

The processor unit 208 may execute Application Generator 226 to generate various UIs for standalone applications and/or for delivery via a web application provided by the Application Server 230, some examples of which are shown and described herein, such as interfaces shown in FIG. 5 and FIG. 6.

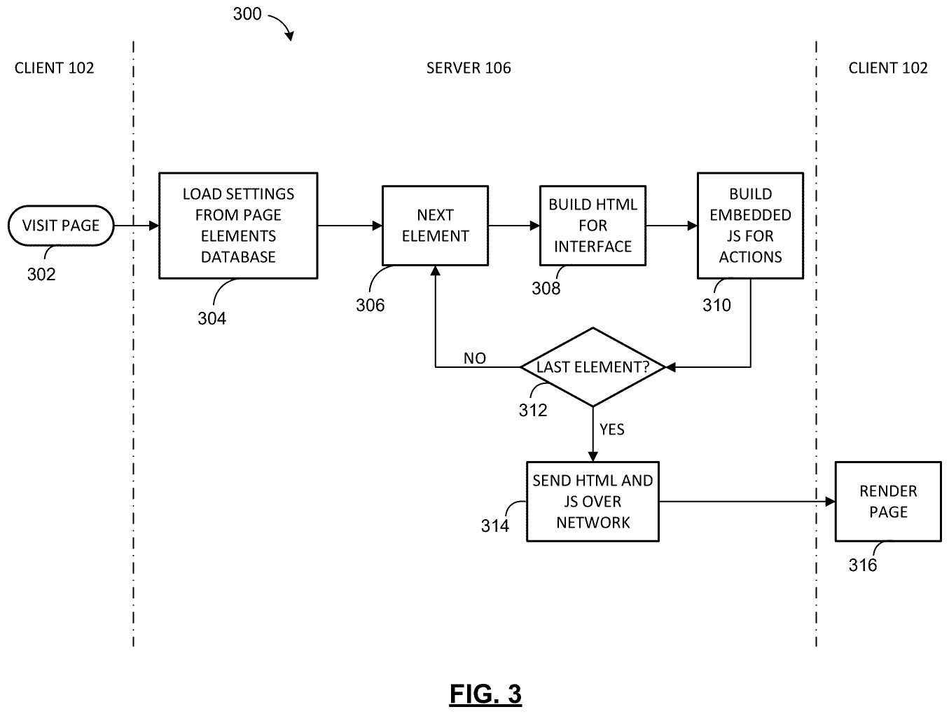

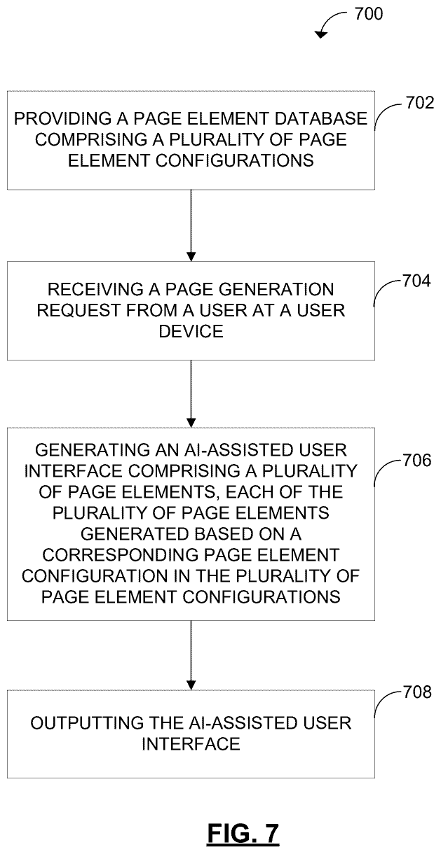

The Application Generator 226 is configured to generate an end-user software application and associated user interfaces based on a page element database. The end-user software application may use an application server 230 that runs on the server 106 and a user interface that is delivered to user device 102 or developer device 110. The Application Generator may cooperate with the Application Server to render the user interface for user device 102. Optionally, the Application Generator 226 may generate a user-interface of the end-user software application in accordance with the example methods shown in FIG. 3 and FIG. 7 described in further detail herein below.

The user interface engine 214 is configured to generate interfaces for users to create, configure, or modify user interfaces and applications for AI-assisted workflows. The various interfaces generated by the user interface engine 214 may be transmitted to a user device by virtue of the Web/API Unit 232 and the communication unit 204.

A particular configuration of a plurality of page elements and/or page element configurations, as defined in the user elements configuration module, may be stored persistently by the server 106. The particular configuration may be persisted by storing the particular configuration as a page elements database in the App Database 228. The particular configuration may be retrieved by the user elements configuration module for future editing or be read by the Application Generator 226 to generate an end-user software application and one or more corresponding user interfaces.

The Application Server 230 may be responsible for executing the back-end business logic of the server. The Application Server 230 may be a commercially available server such as Apache Tomcat, Microsoft IIS, or Django or any other server that has a similar capability.

The Web/API Unit 232 may be a web-based application or Application Programming Interface (API) such as a REST (REpresentational State Transfer) API. The API may communicate in a format such as XML, JSON, or other interchange format.

The Application Server 230 may receive a request to generate a view of a software application from user device 102 via Web/API Unit 232. The server 106 may then apply methods described herein to generate and render a view at a display device of a user device 102. The Application Server 230 may additionally receive a request corresponding to a user submission. For example, the request may be a text input for processing at one or more generative AI systems 108. The server 106 may then apply methods described herein to generate a response by sending a model request, the model request including the input text and a prompt engineering template, to one or more models and receiving at least one corresponding model response. The Application Server 230 may then transmit one or more of the at least one corresponding model responses back to the user device 102.

Referring now to FIG. 3, there is shown a flow diagram of an example method 300 of generating a user interface for a view of a software application. The example method 300 may be implemented by various components of system 100, for instance using the application generator 226 of server 200. In the example illustrated in FIG. 3, the software application is a web application having a backend hosted at the server 106 and a user interface that is sent to a user of the application by way of rendered web pages comprising HTML and JavaScript elements. The backend may include the Application Server 230.

The user may be an end user operating a user device 102, but it is understood that, for any of the methods described herein, the user may be any person accessing the application such as a developer using a developer device 110.

At 302, a page generation request can be sent from a user at a user device 102. For example, the user may visit a webpage corresponding to the desired application on the user device 102. Specifically, the user may navigate to a website URL using a web browser application operating on user device 102.

Optionally, the website URL itself may contain details to specify the application that the user desires to access. For example, the URL may be formatted in the following way: {website URL}/{Google Sheet ID}/{Tab Name}, wherein {website URL} navigates to the server the application is stored on and {Google Sheet ID}/{Tab Name} addresses the page elements database corresponding to the target application stored on the server 106.

At 304, a plurality of page element configurations can be retrieved from the page elements database. The page element configurations can correspond to a predefined set of page element configurations for a custom end-user application defined by a user of a developer device 110.

At 306, an active page element configuration can be examined. As can be seen from method 300, steps 306-312 define an iterative process that is repeated for each active page element configuration in the plurality of page element configurations retrieved at 304. At the first instance of step 306, the active page element configuration may be the first page element configuration in the list of page element configurations. At subsequent instances of step 306, the active page element configuration may be the page element configuration succeeding the previously examined page element configuration.

At 308, HTML corresponding to the active page element configuration can be generated for inclusion in the user interface.

At 310, embedded JavaScript corresponding to the active page element configuration can be generated for inclusion in the user interface.

At 312, the plurality of active page element configurations is evaluated to determine whether the active page element configuration is the last page element configuration in the list. If the active page element configuration is not the last page element configuration in the list, the method returns to 306. If the active page element configuration is the last page element configuration in the list, the method proceeds to 314.

At 314, the server 106 sends the generated HTML and embedded JavaScript associated with the user interface to the user device 102.

At 316, the user device 102 receives the HTML and JavaScript. The user device 102 then renders a webpage containing the user interface using the received HTML and JavaScript. The user device 102 can render the user interface through any tool capable of rendering HTML and JavaScript elements, such as a web browser application for example.

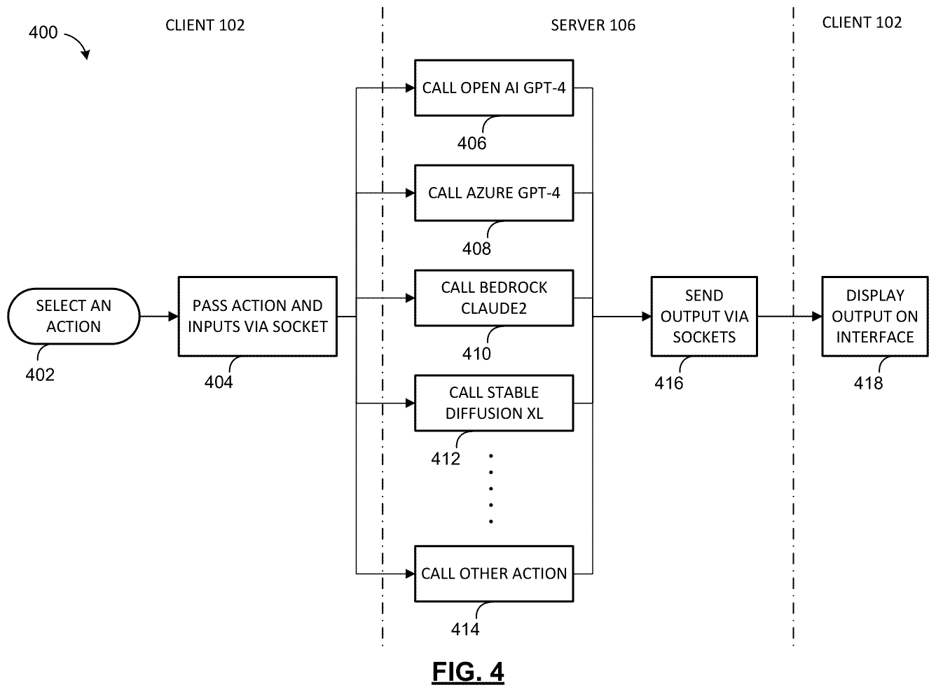

Referring next to FIG. 4, there is shown a flowchart of example method 400 for processing an input from a user device 102 to perform an AI-based action. The example method 300 may be implemented by various components of system 100, for instance using the application server 230 of server 200.

At 402, a user action request can be received by the user device 102. A user of the user device 102 can select an AI-based action through a user interface displayed on the user device 102 to initiate the user action request. For example, the user may interact with an AI-based page element such as a button to initiate an action to process text using one or more generative AI systems 108. The user action request can include user submission data input by the user in association with the action request.

The user interface may be an AI-assisted user interface generated from a page element database comprising a plurality of page element configurations, for instance using the process described above in relation to method 300. The user interface shown on user device 102 can be defined based on a plurality of page element configurations that includes at least one AI-based page element configuration.

At 404, the user device 102 sends the user action request to the server 106.

Optionally, the server 106 may perform user authorization and/or authentication prior to sending the user action request to a generative AI system. For example, the user action require may include a request for protected data. The protected data may be stored in a database that implements access controls or otherwise limited to authorized. The server 106 may then ensure that the user sending the user action request is authorized to access the request data prior to initiating the requested action.

The server 106 may perform various user authentication and user authorization checks prior to initiating the requested action. For instance, the server 106 may transmit an authorization prompt to the user device 102 to prompt the user to input user authentication and authorization data (e.g. username and password, biometric data etc.) prior to initiating the requested action. The authorization prompt may be transmitted to the user device 102 after receiving the user action request to ensure that the user action output is only provided to an authorized user.

At 406-414, the server 106 receives the request and selects one or more generative AI systems 108 that can be used to process the user action request. The server 106 generates a user action output by sending action input data associated with the user action request, such as user submission data, and a predefined prompt, to one or more generative AI systems 108 and receiving a user action response from the one or more generative AI systems 108.

At 416, server 102 sends the user action output to the user device 102.

At 418, the user device 102 displays the user action output on a display of the user device 102. For example, the user device 102 may display the output on the AI-assisted user interface running on a display of the user device 102.

Referring next to FIG. 5, there is shown an example of a User Elements Configuration Module 500 that can be used to provide the user elements configuration module 224 in server 200. In the example illustrated in FIG. 5, User Elements Configuration Module 500 is depicted as being implemented on a spreadsheet.

User Elements Configuration Module 500 may be implemented via a spreadsheet such that each row of the spreadsheet represents a distinct page element. A new page element can be created by populating a new row of the user element configuration spreadsheet. The last page element in a given page element database may then be identified by identifying the last populated spreadsheet row in the corresponding user element configuration spreadsheet. For each page element, the corresponding page element configuration may be specified within the cells of the row corresponding to the page element. In the example illustrated, User Elements Configuration Module 500 includes columns for a section field 502, a component type 504, an element settings field 506, a label field 508, an element ID field 510, an instructions field 512, a default field 514, an options field 516, a prompt/details field 518, an output field 520, and a linked action field 522.

The section field 502 may specify which section a page element is to be generated within. That is, the section field 502 can specify the portion or location within the user interface of a custom end-user application in which that page element is to be generated. A section may correspond to a distinct view or a distinct webpage. Alternatively, a section may merely be a portion of a view or webpage that is divided from other sections using a section divider.

The User Elements Configuration Module may allow developers to specify a component type 504 as a part of a page element configuration. The component type 504 can indicate the type of page element that is being configured. The component type can include a static page element component corresponding to a page element that is static within the user interface of the end user application. The component type can include an input page element component corresponding to a page element that enables a user to provide an input within the user interface of the end user application. The component type can include an output page element component corresponding to a page element that provides an output within the user interface of the end user application. The component type can include an action page element component corresponding to a page element that can be interacted with by a user within the user interface of the end user application to initiate an action.

Examples of component types can include:
Configuration—Supports a special configuration of the entire system, as specified in the element settings field 506
Static: Label—Adds a label at the top of a section or above an input element
Static: iFrame—Adds an iFrame element of a specified size
Static: Break—Adds a break between page elements
Input: Textbox—Adds a textbox of a specified row height as an input
Input: Dropdown—Adds a drop-down menu as an input
Input: Radio—Adds a radio element as an input
Input: Hidden field—Adds a hidden field (with a value) as an input
Output: Textbox—Adds a textbox of a specified row height as an output
Output: Image—Adds an image of a specified size as an output
Output: Video—Adds an image of a specified size as an output
Output: Audio—Adds an audio control of a specified size as an output
Action: Generate AI text—Adds a button and generates text based on a prompt as specified in Prompt/Details field 518
Action: Generate AI image—Adds a button and generates images based on a prompt as specified in Prompt/Details field 518
Action: Generate speech—Adds a button and generates audio based on a prompt as specified in Prompt/Details field 518
Action: Generate graph—Adds a button and generates a graph based on a prompt as specified in Prompt/Details field 518
Action: Load text—Loads information from a source and places the result in the element named in output field 520
Action: Save text—Saves text and places the result in a destination specified in output field 520
Action: Combine—Combines text elements together and places the result in the element named in output field 520
Action: Function—Runs a predefined function located at an address specified in the element settings 506
Action: Index—Indexes a specified source, the source being named in the element settings 506

The User Elements Configuration Module may allow developers to specify element settings 506 for each page element. The element settings 506 may be specified in any way that allows a developer to select values for various parameters. Optionally, the element settings 506 can be specified by defining a string input that conforms with a predefined template. For example, the string input may be defined in the format “parameter=[option1, option2, option 3]”, where in ‘parameter’ refers to a parameter related to the page element to be set, square brackets contain values to be set for the parameter, and option1, option 2, option 3 refer to options that can be selected between for the value. Table 1 lists example page element setting strings for various example page element types.

Element settings for the configuration component type may include a configuration pointer such as a URL directed to a resource containing additional settings in a text format.

Element settings for the Static: Label component type may include a label position parameter setting the position of the label relative to a section or an input element or an output element. Element settings for the Static: iFrame component type may include an iFrame position parameter for positioning the iFrame and parameters for setting the width and height of the iFrame.

Element settings for any input element may include a number of elements parameter defining the number of elements per row. Element settings for the Input: Textbox element may include a number of rows parameter for the number of rows in the textbox.

Element settings for any output element may include a parameter defining the number of elements per row. Element settings for any output element may include a parameter specifying whether the output is automatically read out loud. Element settings for Output: Textbox elements may include a parameter for the number of rows in the textbox. Element settings for Output: Image elements may include a parameter defining the size of the image. Element settings for Output: Video elements may include a parameter defining the size of the video box. Element settings for Output: Audio elements may include a parameter defining the width of the audio player.

Element settings for any action element may include a parameter specifying whether a button is visible, a parameter defining the position of the button, a parameter defining the grouping of the button, a parameter defining the size of the button, a parameter defining the style of the button, and a parameter defining an icon for the button. Element settings for the Action: Generate AI text element may include a parameter selecting one or more generative AI systems 108 to use to process an input, a parameter selecting the temperature, and a parameter defining the maximum number of tokens accepted. Element settings for the Action: Generate AI image element may include a parameter selecting one or more generative AI systems 108 to use to process an input, a parameter defining which version of the generative AI system 108 to use, a parameter defining an output aspect ratio, and a parameter defining the number of iteration steps. Element settings for the Action: Generate speech element may include a parameter selecting one or more generative AI systems 108 to use to process an input, a parameter specifying the voice to use, and a parameter selecting the sampling rate of the voice output. Element settings for the Action: Generate knowledge graph element may include parameters defining the dimensions of the knowledge graph output file.

Element settings for the Action: Load text element may include a parameter defining the source of the text to load and a parameter specifying JSON details. Element settings for the Action: Save text element may include a parameter defining the save destination of the text and a parameter specifying JSON details. Element settings for the Action: Function element may include a parameter defining the type of special function that may be defined. Optionally, the special functions may include functions to combine files, open a URL link using a web browser, assess a reading grade level, and assess a sentiment. Element settings for the Action: Index element may include a parameter defining an address of a network drive to be indexed.

TABLE 1
Example element settings strings

| Page Element Type | Settings |
|---|---|
| Configuration | Sketchpad_url=[{url}] |
| Static: Label | Position=[section_top, section_bottom, input, output] |
| Static: iFrame | position=[section_top, section_bottom, input, output], |
| | type=[general, gdoc, gsheet, gslide, youtube, image], |
| | width=[100px, 200px, 500px, 100%], height=[, 100px, 200px, |
| | 500px, 100%] |
| Any Input | number_per_row=[1, 2] |
| Input: Textbox | rows=[1, 2, 4, 8, 15] |
| Any Output | number_per_row=[1, 2], auto_audio=[false, true] |
| Output: Textbox | rows=[1, 2, 4, 8, 15] |
| Output: Image | size=[100px, 200px, 500px, 100%] |
| Output: Video | width=[100px, 200px, 500px, 100%] |
| Output: Audio | width=[100px, 200px, 500px, 100%] |
| Any Action | visible=[true, false], position=[left, middle], |
| | grouping=[vertical, horizontal], width=[100px, 250px, 100%], |
| | style=[text, icon, both], icon=[fa-bell, fa-check, ...] |
| Action: Generate AI text | engine=[gpt35turbo, gpt4, blip, claude1, claude2], |
| | temperature=[0.0, 0.3, 0.6, 1.0], max_tokens=[1000,2000] |
| Action: Generate AI image | engine=[sd, sd-bedrock, dalle], version=[, sdxl], ratio=[1:1, |
| | 16:9, 2:3], steps=[30, 50] |
| Action: Generate speech | engine=[gcp, 11labs], voice=[random, en-US-Neural2-J,en- |
| | US-Wavenet-F, Yko7PKHZNXotIFUBG719, |
| | 21m00Tcm4TlvDq8ikWAM], rate=[1.0, 1.1, 1.2, 1.5] |
| Action: Generate | full_width=[12], full_height=[12] |
| knowledge graph | |
| Action: Load text | source=[api, gdoc, gslide, bigquery, report, index, |
| | simple_webpage, simple_website, complex_webpage, |
| | complex_website, sitemap], json_details=[{details as json}] |
| Action: Save text | destination=[gdoc, gslide], json_details=[{details as json}] |
| Action: Function | type=[combine, open_url, grade_level, sentiment] |
| Action: Index | source=[gdrive] |

The label field 508 can be used to create a label for a page element that will appear on screen near or on the page element.

The element ID field 510 can be used to create a unique element ID for each element. Each page element may be addressed using an element ID specified in the element ID field 510 for the row the page element is on.

Instructions field 512 can be used to provide an optional set of instructions that will appear below an input or output element.

Default field 514 can be used to provide a default value for inputs which will display if no selection or input is otherwise made by the user.

Options field 516 can be used for Input: Dropdown elements and can be used to specify the options available in the dropdown menu. The options may be separated by commas, semi-colons, or any other method of separating values.

Prompt/Details field 518 can be used to specify or define an input prompt to the selected generative AI system 108 for an AI-based action. Text from other page elements may be inserted in-line with the prompt text. An Element ID for one or more page elements to be inserted may be specified in-line with the input prompt in order to include the contents of the one or more page elements to be inserted in the body of the input prompt text. Optionally, an Element ID for the page element to be inserted may be specified by using double angular brackets surrounding the Element ID of the page element to be inserted. For example, ‘<<Element ID>>’ in the following example prompt: “analyze the following: <<Element ID>>”.

Output field 520 can be used to specify an Element ID of an output page element that the output of the action is to be displayed on.

Linked Action field 522 is for Action page elements and can be used to specify an Element ID of another Action page element that will immediately run following the performance of the selected Action page element. Using Linked Actions, developers may construct automated multi-staged generative AI workflows consisting of multiple AI actions.

Referring next to FIG. 6, there is shown an example user interface 600. User interface 600 is an example of a user interface that can be provided to the user device 102 as part of a custom end-user application. User interface 600 may be displayed on user device 102 through a browser application or an end-user application operating directly on the user device. The example user interface 600 includes a first section 602 and a second section 604. Each section 602/604 contains page elements that are specified to be within the first section 602 or second section 604 respectively in the corresponding page element database used to render the user interface 600.

The user interface also includes a first label 606 shown alone. A second label 608 is shown above an input textbox 610. A third label 618 is shown above a first output textbox 620. A first output textbox 620, second output textbox 622, and third output textbox 624 are also shown within interface 600.

A first action element 612, a second action element 614, and a third action element 616 are shown within user interface. Each action element can include a user interface element that a user can interact with in order to initiate a corresponding action. For example, the first action element 612 is defined as a button configured to produce an action, namely loading a document. The document can be loaded by reading the text from input textbox 610 to identify the document to be loaded and producing an output at first output textbox 620 that includes the content of the identified document.

The second action 614 is defined as a button configured to produce an AI-based action to process text from the loaded document in a first manner. The second action can be performed by reading the text from the first output textbox 620 (generated in response to a user interacting with the first action element 612), combining the contents of the first output textbox 620 with a template prompt (which may be defined in the Prompt/Details field 518 for the second action element within the corresponding page element database), sending the resulting text (from combining the contents of the first output textbox 620 with the template prompt) to one or more generative AI systems, receiving an output from the one or more generative AI systems, and producing the output for display in output textbox 622.

The third action 616 is defined as a button configured to produce an AI-based action to process text from the loaded document in a second manner. The action can be performed using a similar sequence of steps as action 614, but instead reading the contents of textbox 622 to be combined with a predefined template prompt and displaying the output in output textbox 624.

Optionally, the actions 612, 614, 616 may be chained. One action may execute automatically after the other in response to a single input from the user. Optionally, the intermediate outputs (i.e. outputs 620 and 622) may not be shown and only the final resulting output is shown. Optionally, buttons associated with intermediate actions in the chain may not be displayed.

Referring next to FIG. 7, there is shown a flowchart 700 of an example method of generating an AI-assisted user interface. The example method 700 may be implemented by various components of system 100, for instance using the application generator 226 of server 200.

At 702, a page element database can be provided. The page element database can be stored on a non-transitory memory, for instance on server 106. The page element database can include a plurality of page element configurations corresponding to a predefined user interface for an end-user application. The plurality of page elements can include at least one AI-based page element configuration.

At 704, a page generation request can be received from a user at a user device. The page generation request be received in response to a user visiting a webpage or interacting with an application on their user devices as described herein above at step 302 of method 300.

At 706, an AI-assisted user interface can be generated. The AI-assisted user interface can be generated in response to the page generation requested received at 704. The AI-assisted user interface can include a plurality of page elements. Each of the page elements can be generated based on page element configuration in the plurality of page element configurations from the page element database at 702. The AI-assisted user interface may be generated by building HTML and JavaScript code for each page element in accordance with the page element configurations.

At 708, the AI-assisted user interface can be output. The user interface can be output on a display device in communication with the processor, such as a display device of user device 102. Optionally, the AI-assisted user interface may be transmitted by a Web/API Unit, which may include a socket API. Optionally, the user interface may be rendered for display on the display device, for example using a web browser to render the transmitted HTML and JavaScript.

Optionally, the at least one AI-based page element configuration includes at least one selected from the group of an AI-based text generation page element configuration, an AI-based image generation page element configuration, an AI speech generation page element configuration.

Optionally, the AI-based text generation page element configuration includes configuration for at least two Large Language Models (LLMs).

Optionally, the AI-based image generation page element configuration includes configuration for at least two Image Generation Models (IGMs).

Optionally, the AI-based speech generation page element configuration includes configuration for at least two Speech Models (SMs).

Optionally, the page element database includes a spreadsheet.

Optionally, the spreadsheet includes a remote cloud-based spreadsheet system, optionally Google® Sheets®.

Optionally, the plurality of page element configurations includes at least one selected from the group of: a static page element, an input page element, and an output page element.

Optionally, the display device is in network communication with the processor and is located at the user device.

The methods described herein may be performed by a processor in a computer-implemented system comprising a memory, a network device, and the processor in communication with the memory and the network device.

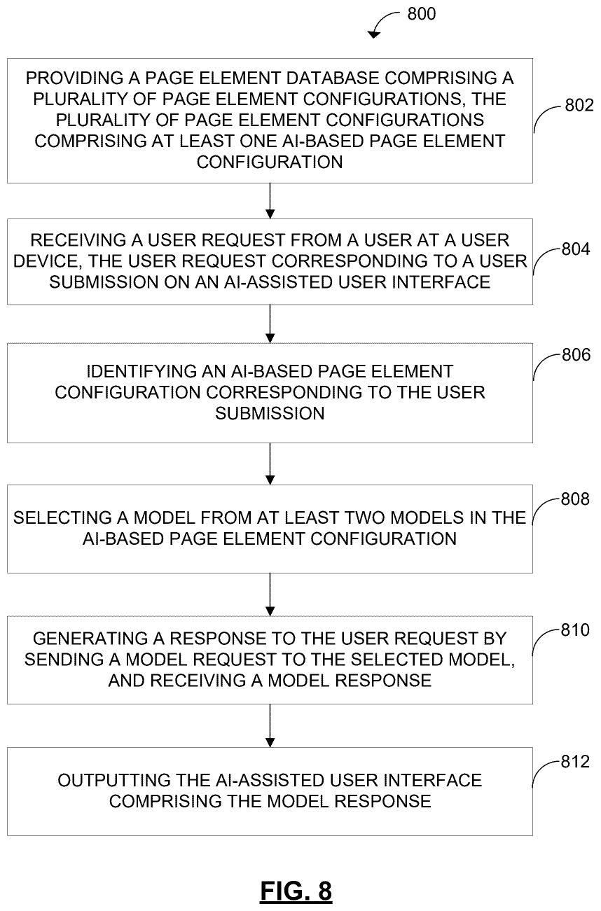

Referring next to FIG. 8, there is shown a flowchart 800 of an example method for processing a user request from an AI-assisted user interface.

At 802, a page element database can be provided. The page element database can include a plurality of page element configurations. The plurality of page element configurations can include at least one AI-based page element configuration.

At 804, a user request can be received from a user at a user device. The user request can correspond to a user submission received through an AI-assisted user interface. The user request may include selecting an action as described herein above with respect to step 402 of method 400.

At 806, an AI-based page element configuration corresponding to the user submission is identified.

At 808, a model is selected from at least two models in the AI-based page element configuration.

At 810, a response to the user request is generated by sending a model request to the selected model and receiving a model response. The model request may comprise making an API call to a model per steps 406, 408, 410, 412, 414 of method 400.

At 812, the AI-assisted user interface including the model response is outputted to a display device.

Optionally, the at least one AI-based page element configuration includes at least one selected from the group of an AI-based text generation page element configuration, an AI-based image generation page element configuration, an AI speech generation page element configuration.

Optionally, the AI-based text generation page element configuration includes configuration for at least two Large Language Models (LLMs).

Optionally, the AI-based image generation page element configuration includes configuration for at least two Image Generation Models (IGMs).

Optionally, the AI-based speech generation page element configuration includes configuration for at least two Speech Models (SMs).

Optionally, the page element database includes a spreadsheet.

Optionally, the spreadsheet includes a remote cloud-based spreadsheet system, optionally Google® Sheets®.

Optionally, the display device is in network communication with the processor and is located at the user device.

The methods described herein may be performed by a processor in a computer-implemented system comprising a memory, a network device, and the processor in communication with the memory and the network device.

The systems, methods and computer program products of the present disclosure have been described here by way of example only. Various modification and variations may be made to these exemplary embodiments without departing from the scope of the invention, which is limited only by the appended claims.

All publications, patents and patent applications are herein incorporated by reference in their entirety to the same extent as if each individual publication, patent or patent application was specifically and individually indicated to be incorporated by reference in its entirety.

1. A computer-implemented method for generating an AI-assisted user interface, comprising:
providing, at a memory, a page element database comprising a plurality of page element configurations;
receiving, at a network device, a page generation request from a user at a user device;
generating, at a processor in communication with the memory and the network device, an AI-assisted user interface comprising a plurality of page elements, each of the plurality of page elements generated based on a corresponding page element configuration in the plurality of page element configurations;
outputting, at a display device in communication with the processor, the AI-assisted user interface; and
wherein the plurality of page element configurations comprises at least one AI-based page element configuration.

2. The method of claim 1, wherein the at least one AI-based page element configuration comprises at least one selected from the group of an AI-based text generation page element configuration, an AI-based image generation page element configuration, an AI speech generation page element configuration.

3. The method of claim 2, wherein the AI-based text generation page element configuration comprises configuration for at least two Large Language Models (LLMs).

4. The method of claim 2, wherein the AI-based image generation page element configuration comprises configuration for at least two Image Generation Models (IGMs).

5. The method of claim 2, wherein the AI-based speech generation page element configuration comprises configuration for at least two Speech Models (SMs).

6. The method of claim 3 wherein the page element database comprises a spreadsheet.

7. The method of claim 6 wherein the spreadsheet comprises a remote cloud-based spreadsheet system.

8. The method of claim 7 wherein the plurality of page element configurations comprises at least one selected from the group of: a static page element, an input page element, and an output page element.

9. The method of claim 1 wherein the display device is in network communication with the processor and is located at the user device.

10. A computer-implemented system for generating an AI-assisted user interface, comprising a memory, a network device, and a processor in communication with the memory and the network device, wherein the processor is configured to:
provide, at the memory, a page element database comprising a plurality of page element configurations;
receive, using the network device, a page generation request from a user at a user device;
generate an AI-assisted user interface comprising a plurality of page elements, each of the plurality of page elements generated based on a corresponding page element configuration in the plurality of page element configurations;
output, at a display device in communication with the processor, the AI-assisted user interface; and
wherein the plurality of page element configurations comprises at least one AI-based page element configuration.

11. A computer-implemented method for processing a user request from an AI-assisted user interface, comprising:
providing, at a memory, a page element database comprising a plurality of page element configurations, the plurality of page element configurations comprises at least one AI-based page element configuration;
receiving, at a network device, a user request from a user at a user device, the user request corresponding to a user submission on an AI-assisted user interface;
identifying, at a processor in communication with the network device and the memory, an AI-based page element configuration corresponding to the user submission;
selecting, at the processor, a model from at least two models in the AI-based page element configuration;
generating, at the processor, a response to the user request by:
sending, using the network device, a model request to the selected model; and
receiving, using the network device, a model response; and
outputting, at a display device in communication with the processor, the AI-assisted user interface comprising the model response.

12. The method of claim 11, wherein the at least one AI-based page element configuration comprises at least one selected from the group of an AI-based text generation page element configuration, an AI-based image generation page element configuration, an AI speech generation page element configuration.

13. The method of claim 12, wherein the AI-based text generation page element configuration comprises configuration for at least two Large Language Models (LLMs).

14. The method of claim 13, wherein the AI-based image generation page element configuration comprises configuration for at least two Image Generation Models (IGMs).

15. The method of claim 14, wherein the AI-based speech generation page element configuration comprises configuration for at least two Speech Models (SMs).

16. The method of claim 15 wherein the page element database comprises a spreadsheet.

17. The method of claim 13 wherein the spreadsheet comprises a remote cloud-based spreadsheet system.

18. The method of claim 11 wherein the display device is in network communication with the processor and is located at the user device.

19. A computer-implemented system for processing a user request from an AI-assisted user interface, comprising: a memory, a network device, a processor in communication with the memory and the network device, wherein the processor is configured to:
provide, at the memory, a page element database comprising a plurality of page element configurations, the plurality of page element configurations comprises at least one AI-based page element configuration;
receive, using the network device, a user request from a user at a user device, the user request corresponding to a user submission on an AI-assisted user interface;
identify an AI-based page element configuration corresponding to the user submission;
select a model from at least two models in the AI-based page element configuration;
generate a response to the user request by:
sending, using the network device, a model request to the selected model; and
receiving, using the network device, a model response; and
output, at a display device in communication with the processor, the AI-assisted user interface comprising the model response.
